(19) United States
(12) Patent Application Publication
(10) Pub. No.: US 2015/0219746 A1
(43) Pub. Date: Aug. 6, 2015

(54) DETERMINING A GEOGRAPHIC LOCATION OF A COMPUTING DEVICE

(71) Applicants: Thomas Christian Wiltzius, Santa Barbara, CA (US); Gregory Matthew Marra, San Francisco, CA (US); Gideon Wald, San Francisco, CA (US); Kathryn Cushing, San Francisco, CA (US)

(72) Inventors: Thomas Christian Wiltzius, Santa Barbara, CA (US); Gregory Matthew Marra, San Francisco, CA (US); Gideon Wald, San Francisco, CA (US); Kathryn Cushing, San Francisco, CA (US)

(73) Assignee: Google Inc., Mountain View, CA (US)

(21) Appl. No.: 13/585,771

(22) Filed: Aug. 14, 2012

(51) Int. Cl. G06F 21/00; H04W 4/02

(52) U.S. Cl. CPC G01S 5/0284; H04W 4/02; G01S 5/0263

(57) ABSTRACT

The disclosed subject matter relates to computer-implemented methods for determining a geographic location of a computing device. In one aspect, a method includes receiving a first set of authentication credentials, corresponding to a user, from a first computing device. The method further includes receiving a second set of authentication credentials, corresponding to the same user, from a second computing device. The method includes correlating the first set of authentication credentials and the second set of authentication credentials, to determine that the same user is associated with each of the first computing device and the second computing device. The method further includes receiving location information from the second computing device. The method further includes associating with the first computing device, based on the correlation, the location information received from the second computing device.

### BACKGROUND

A service may offer personalization based on a user's location. The service may estimate the user's location based on location information received from the user's computing device. However, many computing devices are unable to provide location information. Thus, the service may estimate the user's location based on the public IP address of the computing device that the user is using to access the service.

### SUMMARY

The disclosed subject matter relates to a computer-implemented method for determining a geographic location of a computing device. The method includes receiving a first set of authentication credentials, corresponding to a user, from the first computing device. The method further includes receiving a second set of authentication credentials, corresponding to the same user, from a second computing device. The second computing device is location-aware. The method includes correlating the first set of authentication credentials and the second set of authentication credentials, to determine that the same user is associated with each of the first computing device and the second computing device. The method further includes receiving location information from the second computing device. The method further includes associating with the first computing device, based on the correlation, the location information received from the second computing device.

The disclosed subject matter further relates to a system for determining a geographic location of a computing device. The system includes a memory which includes instructions for determining the geographic location of the computing device, and a processor. The processor is configured to execute the instructions to determine the geographic location of the computing device. The processor is configured to receive a first set of authentication credentials, corresponding to a user, from a first computing device. The processor is further configured to receive a second set of authentication credentials, corresponding to the same user, from a second computing device. The second computing device is location-aware. The processor is configured to correlate the first set of authentication credentials and the second set of authentication credentials, to determine that the same user is associated with each of the first computing device and the second computing device. The processor is further configured to receive location information from the second computing device. The processor is configured to associate with the first computing device, based on the correlation, the location information received from the second computing device. The processor is further configured to send to the first computing device, the location information received from the second computing device.

The disclosed subject matter further relates to a machine-readable medium including machine-readable instructions for causing a processor to execute a method for determining a geographic location of a computing device. The method includes receiving a first set of authentication credentials, corresponding to a user, from a first computing device. The method further includes receiving a second set of authentication credentials, corresponding to the same user, from a second computing device. The method includes correlating the first set of authentication credentials and the second set of authentication credentials, to determine that the same user is associated with each of the first computing device and the second computing device. The method further includes receiving location information from the second computing device. The location information received from the second computing device is based on a GPS signal. The method includes associating with the first computing device, based on the correlation, the location information received from the second computing device. The method further includes sending to the first computing device, the location information received from the second computing device.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative, and not restrictive in nature.

### DESCRIPTION OF DRAWINGS

Certain features of the subject technology are set forth in the appended claims. However, the accompanying drawings, which are included to provide further understanding, illustrate disclosed aspects and together with the description serve to explain the principles of the disclosed aspects. In the drawings:

FIG. 1 illustrates an example of an architecture for determining a geographic location of a computing device.

FIG. 2 is a block diagram illustrating an example of client devices and a server from the architecture of FIG. 1 according to certain aspects of the disclosure.

FIG. 3 illustrates an example of a process for determining a geographic location of a computing device.

FIG. 4 is an illustration of an example of a system associated with the example of the process of FIG. 3.

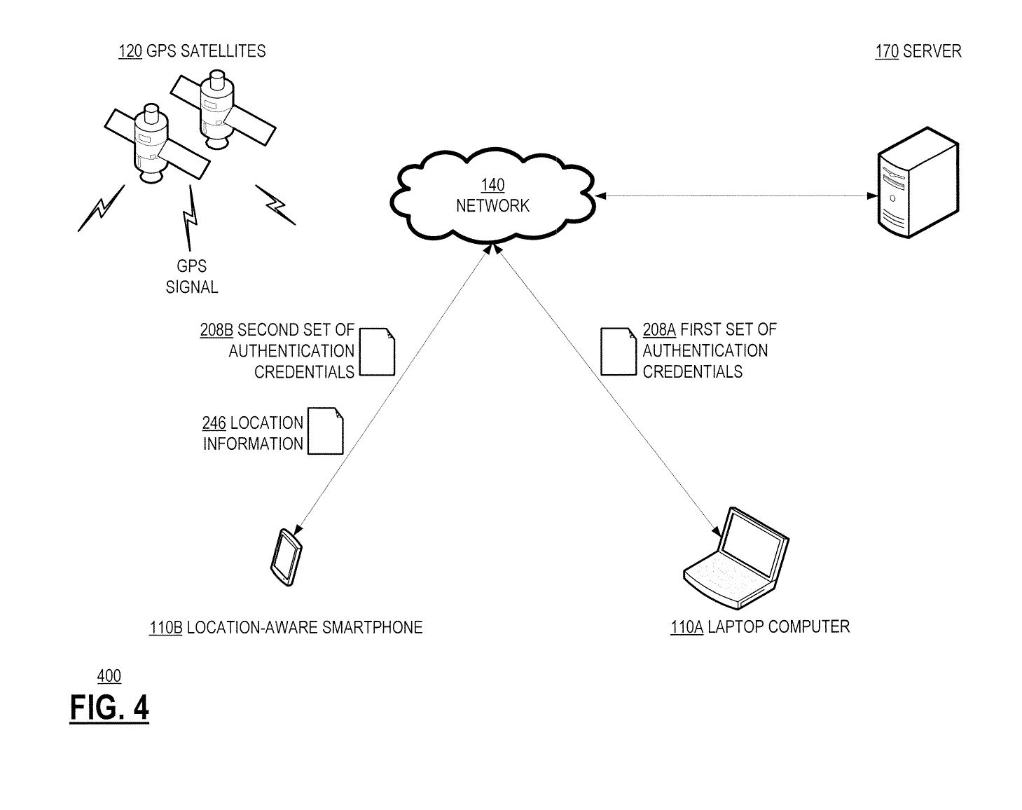

FIG. 5 conceptually illustrates an electronic system with which some aspects of the subject technology can be implemented.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

Determining a computer user's location may be difficult because many computing devices do not contain GPS microchips capable of receiving GPS signals. To determine a user's location, IP geolocation techniques can be used. IP geolocation entails identifying a user's device's IP address, and then looking up that IP address in various databases of known geographic locations. Typically, such IP address databases can provide information down to the granularity of a country, city, and even a post/ZIP code and an employer's name. However, even when IP geolocation functions as designed, it typically does not provide an accurate geographic location and instead provides only an estimate of the user's location.

Furthermore, in certain situations, IP geolocation can fail to provide even a reasonable estimate of a user's location. Examples of such situations arise when the network has an increased level of complexity. For example, when a user is connected to the network via a Virtual Private Network (“VPN”), or the user is behind a Network Proxy, the approach may fail to provide a reasonable estimate of a user's location. As an example, an individual who is employed in Los Angeles, but is currently in London on a business trip can be considered. In order for him to access his work files and email, the user connects to his company using VPN software. Once he connects to the company server in Los Angeles, his computer's IP address is associated with his company's location in Los Angeles. Thus, using IP geolocation techniques, his location will be determined to be Los Angeles instead of his actual location which is London.

Similarly, IP geolocation typically loses accuracy when a user's computer is behind a network proxy. In certain cases, an entire country may be behind a network proxy. In such a case, where an entire country may share a single IP address, IP geolocation techniques would not be able to provide a reasonable estimate of a user's location.

Thus, there exists a need to accurately determine the location of a computing device which may be prevented from, accurately determining its own location.

This document describes systems and techniques for determining the location of a computing device. The system is configured to estimate the geographic location of a first computing device by using location information received from a second computing device.

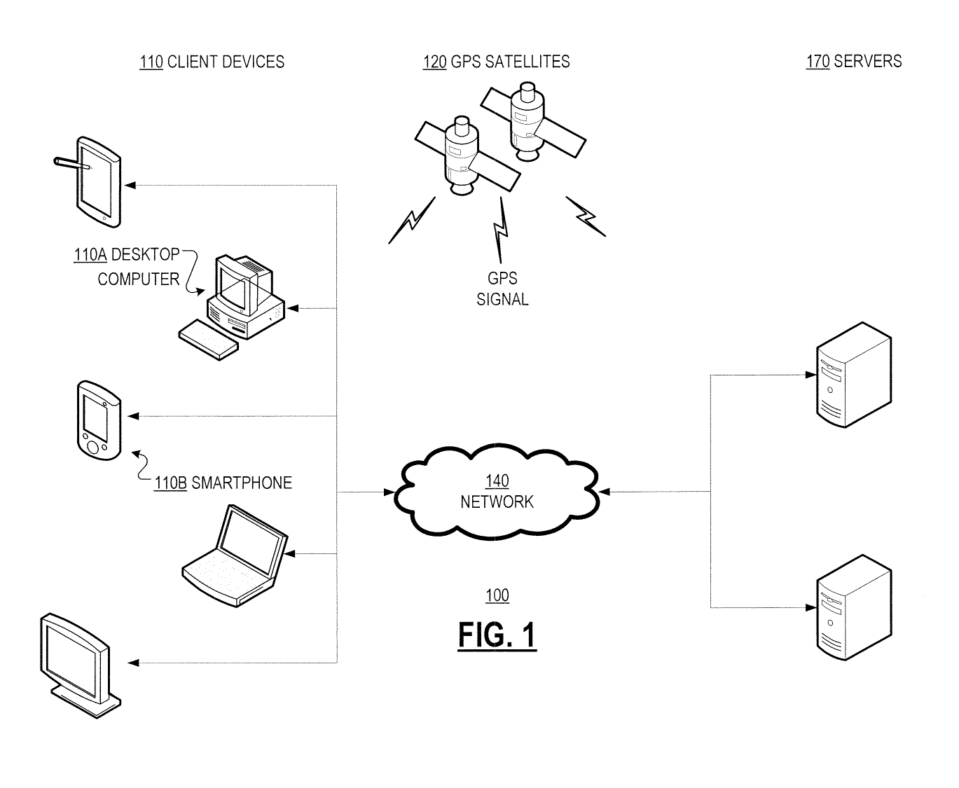

FIG. 1 illustrates an example of an architecture 100 for determining a geographic location of a computing device. The architecture 100 includes client devices 110, and servers 170 connected over a network 140.

As illustrated, the client devices 110 can be, for example, desktop computers, mobile computers, tablet computers, mobile devices (e.g., a smartphone or PDA), set top boxes (e.g., for a television), video game consoles, navigation devices (e.g., GPS based navigation device), or any other devices having appropriate processing capabilities, communications capabilities, and memory. Each client device 110 is configured to include an input device for accepting user input, and an output device to display information to the user.

The clients devices 110 can be connected to the network 140. The network 140 can include any one or more of a personal area network (PAN), a local area network (LAN), a campus area network (CAN), a metropolitan area network (MAN), a wide area network (WAN), a broadband network (BBN), the Internet, and the like. Further, the network 140 can include, but is not limited to, any one or more of the following network topologies, including a bus network, a star network, a ring network, a mesh network, a star-bus network, tree or hierarchical network, and the like.

Any one of the client devices 110 can be a first computing device 110A, and another client device 110 can be a second computing device 110B. For example, in FIG. 1, a desktop computer is illustrated as an example of a first computing device 110A, and a smartphone is illustrated as an example of a second computing device 110B.

The second computing device 110B is a location-aware device. The term ‘location-aware device’ as used herein encompasses its plain and ordinary meaning, including, but not limited to any device which is capable of determining its location without relying on a network-based technique that is susceptible to the flaws described earlier in this document. For example, the smartphone 110B illustrated in FIG. 1 is capable of determining its location based on a GPS signal received from GPS satellites 120. That is, the smartphone 110B may be considered a location-aware device. As another example, a second computing device 110B capable of determining its location based on wireless triangulation techniques may be considered a location-aware device.

It should be noted that regardless of how any information is obtained by the server 170, appropriate efforts may be taken to protect the user's privacy rights. For example, collection of location data (e.g., location information received from the second computing device 110B) may be on an opt-in basis so that data is not collected unless the user has granted permission. Additionally, steps may be taken to anonymize and/or encrypt information to protect the user's privacy rights.

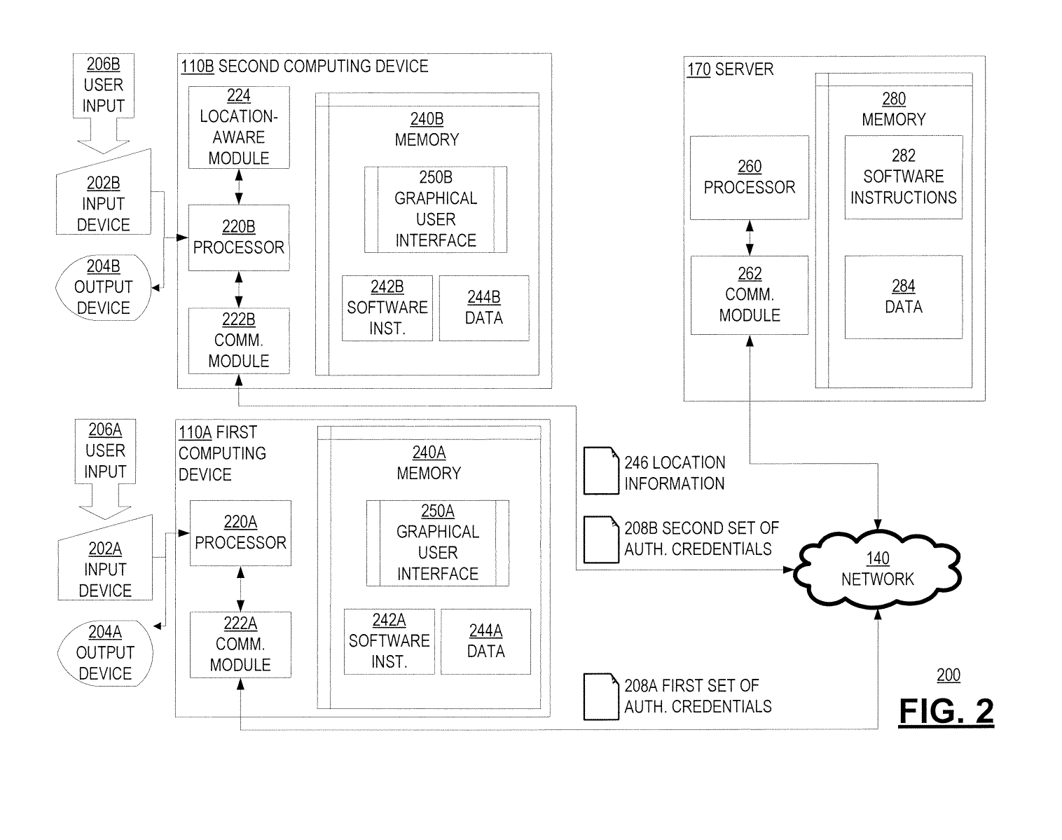

FIG. 2 is a block diagram 200 illustrating an example of a client device 110 acting as a first computing device 110A, a client device 110 acting as a second computing device 110B, and a server 170 in the architecture 100 of FIG. 1 according to certain aspects of the disclosure.

The first computing device 110A includes an input device 202A, an output device 204A, a processor 220A, a communications module 222A, and memory 240A. The input device 202A can be a touchscreen, a mouse, a keyboard, or any other device to enable a user to supply input 206A to the client 110A. The output device 204A can be a display screen. Input 206A received via the input device 202A can be processed locally on the client 110A and/or the server 170.

The first computing device 110A is connected to the network 140 via a communications module 222A. The communications module 222A is configured to interface with the network 140 to send and receive information, such as data, requests, responses, and commands to other devices on the network 140. The communications module 222A can be, for example, a modem or Ethernet card.

The memory 240A includes software instructions 242A and data 244A to enable interaction with the server 170. The memory 240A includes a graphical user interface 250A which allows a user to interact with the first computing device 110A, and can be used to display information to the user. The graphical user interface 250A may be installed locally at the first computing device 110A and/or downloaded from the server 170.

The second computing device 110B is similar to the first computing device 110A in many respects. For example, the second computing device 110B also includes an input device 202B, an output device 204B, a processor 220B, a communications module 222B, and memory 240B. The input device 202B can be a touchscreen, a mouse, a keyboard, or any other device to enable a user to supply input 206B to the client 110B. The output device 204B can be a display screen. Input 206B received via the input device 202B can be processed locally on the second computing device 110B and/or the server 170.

The second computing device 110B is connected to the network 140 via a communications module 222B. The communications module 222B is configured to interface with the network 140 to send and receive information, such as data, requests, responses, and commands to other devices on the network 140. The communications module 222B can be, for example, a modem or Ethernet card.

The memory 240B includes software instructions 242B and data 244B to enable interaction with the server 170. The memory 240B includes a graphical user interface 250B which allows a user to interact with the second computing device 110B, and can be used to display information to the user. The graphical user interface 250B may be installed locally at the second computing device 110A and/or downloaded from the server 170.

Furthermore, the second computing device 110B includes a location-aware module 224. The location-aware module 224 is capable of determining its geographic location using techniques that are not susceptible to the flaws described earlier in this document. For example, the location-aware module 224 may use a GPS signal received from GPS satellites 120 to determine its location. Similarly, the location-aware module 224 may rely on wireless triangulation techniques to determine its location.

The location-aware module 224 can provide location information 246 (e.g., the geographic location) to the server 170.

The server 170 includes a memory 280, a processor 260, and a communications module 262. The memory 280 includes software instructions 282 for storing and/or processing the data 284 for determining a geographic location of a computing device. The server 170 is connected to the network 140 via a communications module 262. The communications module 262 is configured to interface with the network 140 to send and receive information, such as data, requests, responses, and commands to other devices on the network 140. The communications module 262 can be, for example, a modem or Ethernet card.

The processor 260 of the server 170 is configured to execute instructions, such as instructions physically coded into the processor 260, instructions received from the memory 280, or a combination of both. As an example, the processor 260 of the server 170 executes instructions for determining a geographic location of a computing device.

The processor 260 is configured to receive a first set of authentication credentials (e.g., 208A), corresponding to a user, from a first computing device (e.g., 110A). The processor 260 is configured to receive a second set of authentication credentials (e.g., 208B), corresponding to the same user, from a second computing device (e.g., 110B). The processor 260 is configured to correlate the first set of authentication credentials (e.g., 208A) and the second set of authentication credentials (e.g., 208B), to determine that the same user is associated with each of the first and second computing devices. The processor 260 is further configured to receive location information (e.g., 246) from the second computing device (e.g., 110B). The processor 260 is configured to associate with the first computing device (e.g., 110A), based on the correlation, the location information (e.g., 246) received from the second computing device (e.g., 110B). In some implementations, the processor 260 is further configured to send to the first computing device (e.g., 110A), the location information (e.g., 246) received from the second computing device (e.g., 110B).

It should be noted that the first set of authentication credentials 208A received from the first computing device 110A may be the same as, or different than the input 206A provided by the user. For example, in a case where the first set of authentication credentials 208A are received by the server in their original (e.g., unencrypted) form, they may be the same as the input 206A provided by the user. However, in a case where the first set of authentication credentials 208A is in the form of an encrypted username and password, they may different than the input 206A provided by the user. Other examples of authentication credentials that may be different than the input provided by a user can include a digital certificate or a token. Similarly, the second set of authentication credentials 208B received from the second computing device 110B may be the same as, or different than the input 206B provided by the user.

However, regardless of whether the first set of authentication credentials 208A and the second set of authentication credentials 208B are the same, each set of authentication credentials 208A, 208B corresponds to the same user.

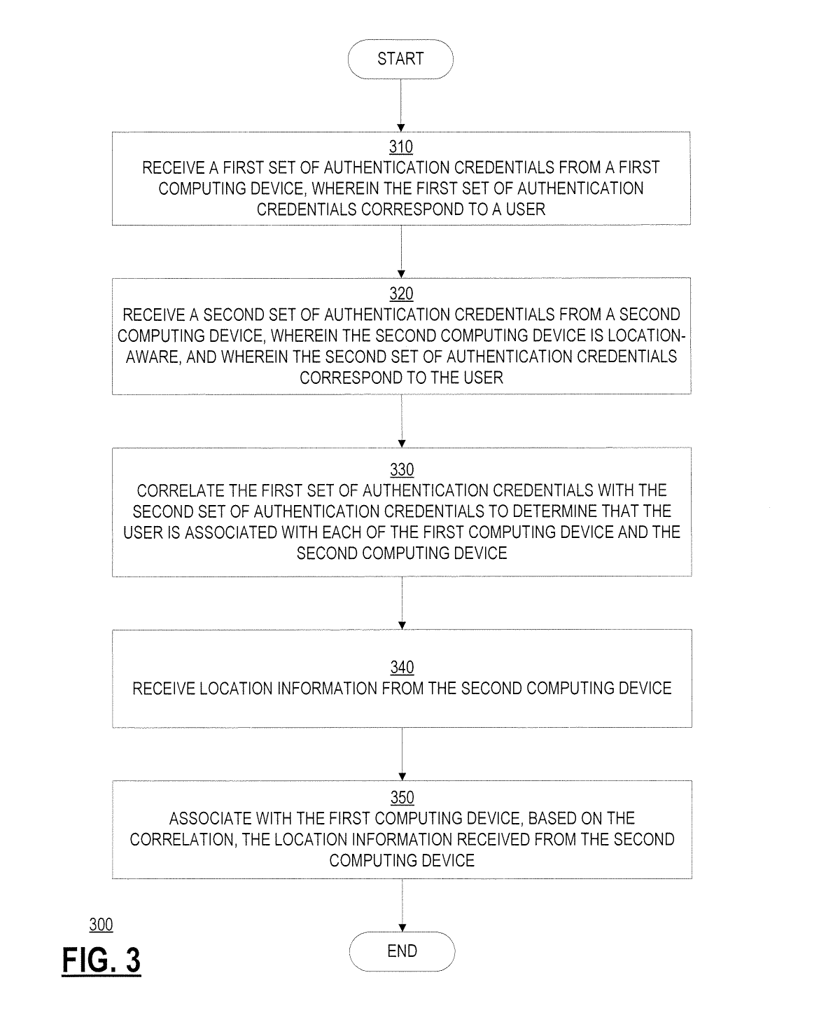

FIG. 3 illustrates an example of a process 300 for determining a geographic location of a computing device. In step 310, a first set of authentication credentials 208A, corresponding to a user, is received from a first computing device 110A. The first set of authentication credentials 208A may be received for authentication to a service provided by the server 170. As an example, if the service provided by the server 170 is web-based email, the first set of authentication credentials 208A may be received for authentication (e.g., signing in) to the web-based email service.

In step 320, a second set of authentication credentials 208B, corresponding to the same user, is received from a second computing device 110B. The second set of authentication credentials 208B may be for authentication to the same service for which the first set of authentication credentials 208A were received. As an alternative, the second set of authentication credentials 208B received from the second computing device 110B may be for authentication to a different service.

In step 330, the first set of authentication credentials 208A and the second set of authentication credentials 208B are correlated to determine that the same user is signed in on both the first and second computing devices 110A and 110B. In a case where the first set of authentication credentials 208A and the second set of authentication credentials 208B are received for two different services, the two services may be configured to interact with each other, and/or the server 170 may be configured to interact with each of the services. By interacting with each of the services, the server 170 may be able to correlate the sets of authentication credentials 208A and 208B.

In step 340, location information 246 is received from the second computing device 110B. The location information 246 is determined by the location-aware module 224 of the second computing device 110B. The location information 246 may be in the form of GPS coordinates. Alternatively, the location information may be based on wireless triangulation techniques.

The location information 246 may be received from the second computing device 110B on demand. As an example, the server 170 may request the location information 246 from the second computing device 110B. As another example, the user may select an option to provide the location information 246 to the server.

The location information 246 may be received from the second computing device 110B based on a trigger event. As an example, the second computing device 110B may include a motion sensor that, upon sensing movement, may cause the location information 246 to be provided to the server 170. As another example of a trigger event, the second computing device 110B may provide location information 246 upon entering or exiting an area. That is, if the second computing device 110B senses that it has been moved more than a certain distance from its last known position, it may provide its location information 246 to the server 170.

The location information 246 may be received from the second computing device 110B periodically or continuously. That is, the location information 246 may be received at a particular time interval or continuously, regardless of any trigger events, or requests for location.

The server 170 may estimate, based on an IP address, the location of the first computing device 110A. Based on the estimated location of the first computing device 110A, and the location indicated in the location information most recently received from the second computing device, the server can determine an approximate distance between the two computing devices. If the server determines that the first computing device 110A appears to be communicating from an IP address associated with a location that is beyond a specified distance from the location indicated in the location information 246 provided by the second computing device 110B, the server 170 may take further steps to resolve the conflict. As an example, the server 170 may request updated location information 246 from the second computing device 110B. As another example, the server 170 may send a prompt to be displayed at one or both of the computing devices 110A and 110B requesting confirmation from the user that the devices are indeed near each other.

In step 350, the location information 246 received from the second computing device 110B is associated with the first computing device 110A, based on the correlation between the first and second sets of authentication credentials, 208A and 208B.

The server 170 may send the location information 246 to the first computing device 110A. The first computing device 110A may receive the location information 246 via a variety of approaches. For example, the software instructions 242A on the first computing device 110A may receive the location information 246. Implementations of software instructions 242A can include a service (e.g., as a part of the operating system), a program that can be added to another program (e.g., a plugin that can be added to a browser), or a separate program (e.g., a program that can be installed on a computer). Upon receiving the location information 246, the first computing device 110A may then accurately report its location to the server 170 and/or other services offered by other unrelated servers.

It should be noted that the above process is not limited to two computing devices, and may be extended to any number of computing devices so long as the authentication credentials received from each of the computing devices may be correlated with each other.

In some instances, it may be possible that a user may have more than one location-aware computing device. In such a case, the server 170 may be configured to use an order of precedence to prefer one type of device over another, or a specific device over another. As an example, if a user has a location-aware smartphone and a location-aware laptop computer, each of which provide location information to the server 170, the location information received from the smartphone may be given precedence. This precedence may be based on an assumption that the user is more likely to carry their smartphone than their laptop computer. Other assumptions may be used to define other orders of precedence. Furthermore, based on the preferences and/or habits of a particular user, a specific order of precedence may be determined for that user.

An example will now be described using the example of the process 300 of FIG. 3. In this example, a laptop computer will be used as the first computing device 110A, and a smartphone will be used as a second computing device 110B. The smartphone 110B includes a GPS-based location aware module 224.

In step 310, a first set of authentication credentials 208A, corresponding to a user, is received from the laptop computer 110A. This first set of authentication credentials 208A is in the form of the user's username and password. The user provides the username and password as input 206A via a graphical user interface 250A for a web-based account. The web-based account is linked to a number of services including a personalized start page, email, calendar, contacts, and documents.

In step 320, a second set of authentication credentials 208B, corresponding to the same user, is received from the smartphone 110B. The second set of authentication credentials is in the form of the user's username and password for the same web-based account. That is, in this example, the user is signing into the same service from the laptop computer 110A and the smartphone 110B.

In step 330, the server 170 correlates the first set of authentication credentials 208A and the second set of authentication credentials 208B. By correlating the two sets of usernames and passwords, the server 170 determines that the same user is signed in from both the laptop 110A and the smartphone 110B.

In step 340, location information 246 is received from the smartphone 110B. In this example, the smartphone 110B includes a GPS based location-aware module 224. That is, the location information 246 received from the smartphone 110B includes GPS coordinates that are calculated based on a GPS signal received from GPS satellites.

In step 350, the server 170 associates with the laptop 110A, based on the correlation between the first set of authentication credentials 208A and the second set of authentication credentials, the GPS coordinates 246 received from the smartphone HOB.

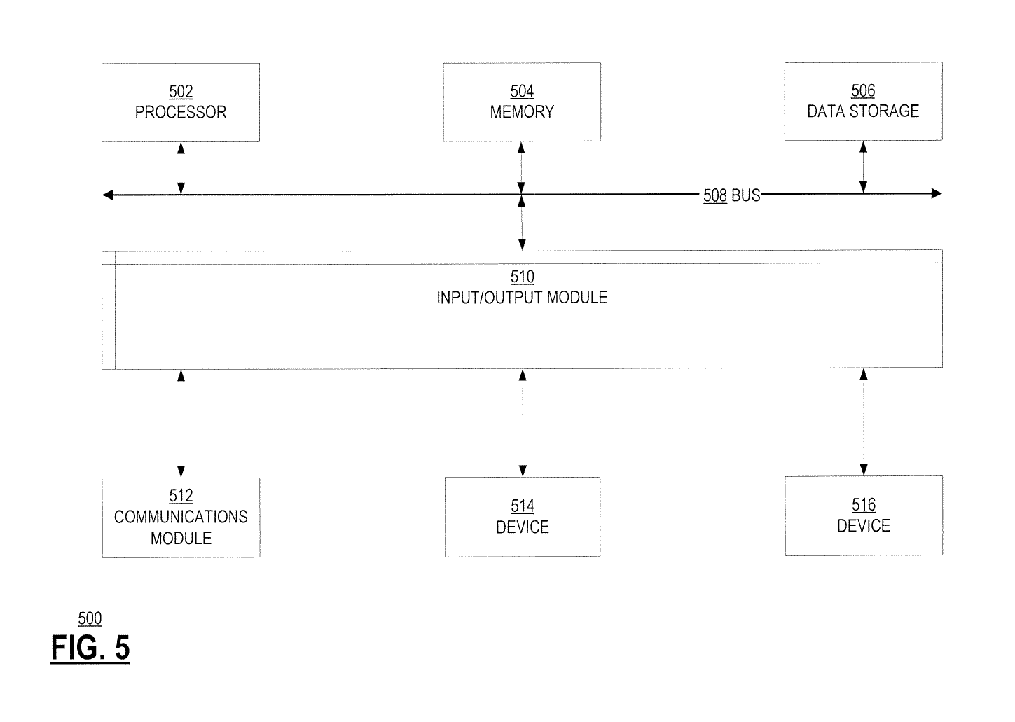

FIG. 5 is a block diagram illustrating an example of a computer system 500 with which the client 110 of FIG. 2 can be implemented. In certain aspects, the computer system 500 may be implemented using hardware or a combination of software and hardware, either in a dedicated server, or integrated into another entity, or distributed across multiple entities.

Computer system 500 (e.g., client 110) includes a bus 508 or other communication mechanism for communicating information, and a processor 502 (e.g., processor 220) coupled with bus 508 for processing information. By way of example, the computer system 500 may be implemented with one or more processors 502. Processor 502 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 500 can include, in addition to hardware, code that creates an execution environment for the computer program in question, e.g., code that constitutes processor firmware, a protocol stack, a database management system, an operating system, or a combination of one or more of them stored in an included memory 504 (e.g., memory 240), such as a Random Access Memory (RAM), a flash memory, a Read Only Memory (ROM), a Programmable Read-Only Memory (PROM), an Erasable PROM (EPROM), registers, a hard disk, a removable disk, a CD-ROM, a DVD, or any other suitable storage device, coupled to bus 508 for storing information and instructions to be executed by processor 502. The processor 502 and the memory 504 can be supplemented by, or incorporated in, special purpose logic circuitry.

The instructions may be stored in the memory 504 and implemented in one or more computer program products, i.e., one or more modules of computer program instructions encoded on a computer readable medium for execution by, or to control the operation of, the computer system 500, and according to any method well known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perk Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, embeddable languages, and xml-based languages. Memory 504 may also be used for storing temporary variable or other intermediate information during execution of instructions to be executed by processor 502.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 500 further includes a data storage device 506 such as a magnetic disk or optical disk, coupled to bus 508 for storing information and instructions. Computer system 500 may be coupled via input/output module 510 to various devices. The input/output module 510 can be any input/output module. Examples of input/output modules 510 include data ports such as USB ports. The input/output module 510 is configured to connect to a communications module 512. Examples of communications modules 512 (e.g., communications module 222) include networking interface cards, such as Ethernet cards and modems. In certain aspects, the input/output module 510 is configured to connect to a plurality of devices, such as an input device 514 (e.g., input device 202) and/or an output device 516 (e.g., output device 204). Examples of input devices 514 include a keyboard and a pointing device, e.g., a mouse or a trackball, by which a user can provide input to the computer system 500. Other kinds of input devices 514 can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback; and input from the user can be received in any form, including acoustic, speech, tactile, or brain wave input. Examples of output devices 516 include display devices, such as a CRT (cathode ray tube) or LCD (liquid crystal display) monitor, for displaying information to the user.

According to one aspect of the present disclosure, the client 110 can be implemented using a computer system 500 in response to processor 502 executing one or more sequences of one or more instructions contained in memory 504. Such instructions may be read into memory 504 from another machine-readable medium, such as data storage device 506. Execution of the sequences of instructions contained in main memory 504 causes processor 502 to perform the process steps described herein. One or more processors in a multi-processing arrangement may also be employed to execute the sequences of instructions contained in memory 504. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. The communication network (e.g., network 140) can include, for example, any one or more of a personal area network (PAN), a local area network (LAN), a campus area network (CAN), a metropolitan area network (MAN), a wide area network (WAN), a broadband network (BBN), the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

Computing system 500 can include clients and servers. A client and server are generally remote from each other and typically interact through a communication network. The relationship of client and server arises by virtue of computer programs running on the respective computers and having a client-server relationship to each other. Computer system 500 can be, for example, and without limitation, a desktop computer, laptop computer, or tablet computer. Computer system 500 can also be embedded in another device, for example, and without limitation, a mobile telephone, a personal digital assistant (PDA), a mobile audio player, a Global Positioning System (GPS) receiver, a video game console, and/or a television set top box.

The term “machine-readable storage medium” or “computer readable medium” as used herein refers to any medium or media that participates in providing instructions to processor 502 for execution. Such a medium may take many forms, including, but not limited to, non-volatile media, volatile media, and transmission media. Non-volatile media include, for example, optical or magnetic disks, such as data storage device 506. Volatile media include dynamic memory, such as memory 504. Transmission media include coaxial cables, copper wire, and fiber optics, including the wires that include bus 508. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter effecting a machine-readable propagated signal, or a combination of one or more of them.

While this specification contains many specifics, these should not be construed as limitations on the scope of what may be claimed, but rather as descriptions of particular implementations of the subject matter. Certain features that are described in this specification in the context of separate implementations of the subject technology can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products.

The subject matter of this specification has been described in terms of particular aspects, but other aspects can be implemented and are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other variations are within the scope of the following claims.

These and other implementations are within the scope of the following claims.

1. A computer-implemented method for determining a geographic location of a computing device, the method comprising:
receiving a first set of authentication credentials from a first computing device, wherein the first computing device is not location-aware, wherein the first set of authentication credentials correspond to a user;
receiving a second set of authentication credentials from a second computing device, wherein the second computing device is location-aware and able to determine its location based on one or more of a Global Positioning System (GPS) signal and wireless triangulation techniques, and wherein the second set of authentication credentials correspond to the user;
correlating the first set of authentication credentials and the second set of authentication credentials, to determine that the user is currently signed-on to each of the first computing device and the second computing device;
receiving location information from the second computing device as determined from one or more of a GPS signal and wireless triangulation techniques provided at the second computing device; and
in response to determining that the user is currently signed-on to each of the first computing device and the second computing device, estimating a geographic location for the first computing device based on the location information received from the second computing device.

2. The computer-implemented method of claim 1, further comprising, sending to the first computing device, the location information received from the second computing device.

3. The computer-implemented method of claim 1, further comprising:
estimating, based on an Internet Protocol (IP) address, a first location of the first computing device;
determining a distance between a second location indicated in the location information received from the second computing device, wherein the second location is determined from one or more of a GPS signal and wireless triangulation techniques provided at the second computing device, and the estimated first location of the first computing device;
sending, based on the determined distance, a request to the second computing device for an updated location information.

4. The computer-implemented method of claim 1, wherein the location information received from the second computing device is based on a Global Positioning System (GPS) signal.

5. The computer-implemented method of claim 1, wherein a service associated with the first set of authentication credentials received from the first computing device, is the same as a service associated with the second set of authentication credentials received from the second computing device.

6. The computer-implemented method of claim 1, wherein a first service associated with the first set of authentication credentials received from the first computing device, is configured to communicate with a second service associated with the second set of authentication credentials received from the second computing device.

7. The computer-implemented method of claim 1, wherein the location information from the second computing device is received based on a trigger, wherein the trigger comprises a movement, an entry into an area, or an exit from the area.

8. The computer-implemented method of claim 1, wherein the location information from the second computing device is received periodically.

9. A system for determining a geographic location of a computing device, the system comprising:
a memory comprising instructions for determining the geographic location of the computing device;
a processor configured to execute the instructions to:
receive a first set of authentication credentials from a first computing device, wherein the first computing device is not location-aware, and wherein the first set of authentication credentials correspond to a user;
receive a second set of authentication credentials from a second computing device, wherein the second computing is location-aware and able to determine its location based on one or more of a Global Positioning System (GPS) signal and wireless triangulation techniques, and wherein the second set of authentication credentials correspond to the user;
correlate the first set of authentication credentials and the second set of authentication credentials, to determine that the user is currently signed-on to each of the first computing device and the second computing device;
receive location information from the second computing device, the location information providing a location of the second computing device as determined from one or more of a GPS signal and wireless triangulation techniques provided at the second computing device;
in response to determining that the user is currently signed-on to each of the first computing device and the second computing device, estimate a geographic location for the first computing device based on the location the second computing device; and
send to the first computing device, the location information received from the second computing device.

10. The system of claim 9, wherein the processor is further configured to:
estimate, based on an Internet Protocol (IP) address, a first location of the first computing device;
determine an approximate distance between a second location indicated in the location information received from the second computing device, wherein the second location is determined from one or more of a GPS signal and wireless triangulation techniques provided at the second computing device, and the estimated first location of the first computing device; and
determine that the approximate distance is not beyond a specified distance; and
wherein sending the location information received from the second computing device to the first computing device is done in further response to the determining that the approximate distance is not beyond a specified distance.

11. The system of claim 9, wherein the location information received from the second computing device is based on a Global Positioning System (GPS) signal.

12. The system of claim 9, wherein a service associated with the first set of authentication credentials received from the first computing device, is the same as a service associated with the second set of authentication credentials received from the second computing device.

13. The system of claim 9, wherein a first service associated with the first set of authentication credentials received from the first computing device, is configured to communicate with a second service associated with the second set of authentication credentials received from the second computing device.

14. The system of claim 9, wherein the location information from the second computing device is received based on a trigger, wherein the trigger may be a movement, an entry into an area, or an exit from the area.

15. A non-transitory machine-readable storage medium comprising machine-readable instructions for causing a processor to execute a method for determining a geographic location of a computing device, the method comprising:
receiving a first set of authentication credentials from a first computing device, wherein the first computing device is not location-aware, and wherein the first set of authentication credentials correspond to a user;
receiving a second set of authentication credentials from a second computing device, wherein the second computing device is location-aware and able to determine its location based on a Global Positioning System (GPS) signal, and wherein the second of authentication credentials correspond to the user;
correlating the first set of authentication credentials and the second set of authentication credentials to determine that the user is currently signed-on to each of the first computing device and the second computing device;
receiving location information from the second computing device, wherein the location information received from the second computing device is based on a Global Positioning System (GPS) signal;
in response to determining that the user is currently signed-on to each of the first computing device and the second computing device, estimating a geographic location for the first computing device based on the location information received from the second computing device; and
sending to the first computing device, the location information received from the second computing device.

16. The non-transitory machine-readable storage medium of claim 15, wherein the method further comprises:
estimating, based on an Internet Protocol (IP) address, a first location of the first computing device;
determining an approximate distance between a second location indicated in the location information received from the second computing device, wherein the second location is determined from one or more of a GPS signal and wireless triangulation techniques provided at the second computing device, and the estimated first location of the first computing device; and
determining that the approximate distance is not beyond a specified distance; and
wherein sending the location information received from the second computing device to the first computing device is done in further response to the determining that the approximate distance is not beyond a specified distance.

17. The non-transitory machine-readable storage medium of claim 15, wherein a service associated with the first set of authentication credentials received from the first computing device, is the same as a service associated with the second set of authentication credentials received from the second computing device.

18. The non-transitory machine-readable storage medium of claim 15, wherein a first service associated with the first set of authentication credentials received from the first computing device, is configured to communicate with a second service associated with the second set of authentication credentials received from the second computing device.

19. The non-transitory machine-readable storage medium of claim 15, wherein the location information from the second computing device is received based on a trigger, wherein the trigger may be a movement, an entry into an area, or an exit from the area.

20. The non-transitory machine-readable storage medium of claim 15, wherein the location information from the second computing device is received periodically.
